(19) United States
(12) Patent Application Publication
(10) Pub. No.: US 2010/0038356 A1
(43) Pub. Date: Feb. 18, 2010

(54) SHEET HEATING ELEMENT

(75) Inventors: Hirosi Fukuda, Nara (JP); Katsuhiko Uno, Nara (JP); Takahito Ishii, Kyoto (JP); Keizo Nakajima, Osaka (JP); Akihiro Umeda, Nara (JP)

Correspondence Address: Brinks Hofer Gilson & Lione/Panasonic, P.O. Box 10395, Chicago, IL, 60610, US

(73) Assignee: Panasonic Corporation, Kadoma-shi ,Osaka (JP)

(21) Appl. No.: 12/521,957

(22) PCT Filed: Jan. 22, 2008
(86) PCT No.: PCT/JP2008/051146

§ 371 Date: Jul. 1, 2009

(30) Foreign Application Priority Data
Jan. 22, 2007 (JP) 2007-010995
Jan. 22, 2007 (JP) 2007-010996
Jan. 22, 2007 (JP) 2007-010997
Jan. 22, 2007 (JP) 2007-010998
Jan. 22, 2007 (JP) 2007-010999
Jan. 22, 2007 (JP) 2007-011000
Jun. 27, 2007 (JP) 2007-168439

(51) Int. Cl. H05B 3/34

(52) U.S. Cl. 219/549

(57) ABSTRACT

The sheet heating element according to the present invention comprises a substrate sheet made of an electrically insulative material and lines made of electrically conductive materials and arranged with a distance between them on the substrate sheet. The sheet heating element further comprises at least one PTC resistor sheet being in electrical contact with the lines and configured to heat up in a self-regulated manner in response to a supply of electricity from the lines. The at least one PTC resistor sheet may comprise a flame retardant agent and/or a liquid-resistant resin. The sheet heating element according to the present invention has excellent flexibility, durability, and reliability, as well as low manufacturing cost. When the sheet heating element of the present invention is used in a car seat heater or in a steering wheel heater, the passenger feels comfortable when seated thereon, and the driver feels comfortable when touching the steering wheel.

### TECHNICAL FIELD

The present invention relates to a heating element, and in particular, the present invention relates to a sheet heating element with an excellent a PTC characteristic. The sheet heating element has a characteristic of being so highly flexible that it can be mounted on a surface of any shape of an appliance.

### BACKGROUND ART

PTC characteristic refers to a characteristic such that when the temperature rises, resistance rises with it. A sheet heating element having such a PTC characteristic has self-temperature control of the heat which it emits. Heretofore, a resistor was used in the heat-emitting member of such a sheet heating element. This resistor was formed from a resistor ink with a base polymer and a conductive material dispersed in a solvent.

This resistor ink is printed on a base material forming a heating element. The ink is dried, and then baked to form a sheet-shaped resistor (e.g., see Patent Reference 1, Patent Reference 2, and Patent Reference 3). This resistor emits heat by conducting electricity. A conductive material used in this type of resistor is typically carbon black, metal powder, graphite, and the like. A crystalline resin is typically used as a base polymer. A sheet heating element formed from such materials exhibits a PTC characteristic.

FIG. 1A is a plan view of a prior art sheet heating element described in Patent Reference 1. For the sake of description, the drawing gives a transparent view into the internal structure of the heating element. FIG. 1B is a sectional view along the line 1B-1B in FIG. 1A. As shown in FIG. 1A and FIG. 1B, a sheet heating element 10 is formed from a substrate 11, a pair of electrodes 12, 13, a polymer resistor 14, and a cover material 15. The electrodes 12, 13 form a comb-like shape. The substrate 11 is a material with electrical insulating properties, and is formed from a resin, and is, for instance, a polyester film.

The electrodes 12, 13 are formed by printing a conductive paste such as a silver paste on the substrate 11 and then allowing it to dry. The polymer resistor 14 makes electrical contact with the comb-shaped electrodes 12, 13, and is electrically fed by these electrodes. The polymer resistor 14 has a PTC characteristic. The polymer resistor 14 is formed from a polymer resistor ink, and this ink is printed and dried in a position to make electrical contact with the electrodes 12, 13 on the substrate. The cover material 15 is formed from the same type of material as the substrate 11, and protects the electrodes 12, 13 and the polymer resistor 14 by covering them.

In cases where a polyester film is used as the substrate 11 and the cover material 15, a hot-melt resin 16 such as modified polyethylene is caused to adhere to the cover material 15 in advance. Then, while applying heat, the substrate 11 and the cover material 15 are compressed. Accordingly, the substrate 11 and the cover material 15 are joined. The cover material 15 and the hot-melt resin 16 isolate the electrodes 12, 13 and the polymer resistor 14 the external environment. For this reason, the reliability of the sheet heating element 10 is maintained for a long time.

FIG. 2 shows an abbreviated sectional view of the structure of a device which applies the cover material 15. As shown in the drawing, a laminator 22 formed with two hot rollers 20, 21 performs thermal compression. In this process, the substrate 11 on which the electrodes 12, 13 and the polymer resistor 14 are formed in advance, and the cover material 15 to which the hot-melt resin 16 is applied in advance, are placed on top of each other and supplied to the laminator 22. They are thermally compressed with the hot rollers 20, 21, forming the sheet heating element 10 as a unit.

A polymer resistor formed in such a manner has a PTC characteristic, and the resistance value rises due to the rise in temperature, and when a certain temperature is reached, the resistance value dramatically increases. Since the polymer resistor 14 has a PTC characteristic, the sheet heating element 10 has a self-temperature control function.

Patent Reference 2 discloses a PTC composition formed from an amorphous polymer, crystalline polymer particles, conductive carbon black, graphite, and an inorganic filler. This PTC composition is dispersed in an organic solvent to produce an ink. Then, the ink is printed on a resin film provided with electrodes, to produce a polymer resistor. Additionally, heat treatment is performed to achieve cross-linking. A resin film is deposited on the polymer resistor as a protective layer, thereby completing a sheet heating element. This sheet heating element of Patent Reference 2 has the same PTC heat-emitting characteristic as in Patent Reference 1.

FIG. 3 shows a sectional view of another prior art sheet heating element described in Patent Reference 3. As shown in FIG. 3, a sheet heating element 30 has a flexible substrate 31.

Electrodes 32, 33 and a polymer resistor 34 are successively deposited onto this flexible substrate 31 by printing. Then, on top of this is formed a flexible cover layer 35. The substrate 31 has a gas-barrier property and a waterproof property. The substrate 31 comprises a polyester non-woven fabric including long fibers, and a hot-melt film such as of the polyurethane type is bonded to the surface of this polyester non-woven fabric. The substrate 31 can be impregnated with a liquid, such as a polymer resistor ink.

The cover layer 35 comprises a polyester non-woven fabric, and a hot-melt film such as of the polyester type is bonded to the surface of this polyester non-woven fabric. The cover layer 35 also has a gas-barrier property and a waterproof property. The cover layer 35 is adhered to the substrate 31, covering the entirety of the electrodes 32, 33 and the polymer resistor 34. The sheet heating element 30 of Patent Reference 3 is formed in its entirety from six layers. This sheet heating element of Patent Reference 3 also has the same PTC heat-emitting characteristic as in Patent Reference 1.

In the prior art sheet heating element 10 of Patent Reference 1 and Patent Reference 2, a rigid material such as a polyester film is used as the substrate 11. In addition, the prior art heating element 10 has a five-layered structure formed from the substrate 11, comb-shaped electrodes 12, 13 printed thereon, the polymer resistor 14, and a cover material 15 having an adhesive layer disposed thereon. As its thickness grows, the sheet heating element 10 loses flexibility. When such a sheet heating element 10 lacking in flexibility is used as a car seat heater, the passenger's seating comfort is compromised. When such a sheet heating element 10 lacking in flexibility is used in a steering wheel heater, the comfortable gripping feel is compromised.

Since the heating element 10 is in the shape of a sheet, for example, when used as a car seat heater and a passenger sits thereon, the force extends to the heating element as a whole, and the heating element 10 changes the shape. Typically, the closer to the edge of the heating element 10, the greater the magnitude of deformation. Thus, wrinkles form unevenly on the heating element. Cracks in the comb-shaped electrodes 12, 13 and in the polymer resistor 14 may result from these wrinkles. Accordingly, such a heating element is thought to have low durability.

The polyester sheets used in the substrate 11 and in the cover material 15 have no ventilation properties. Thus, when the heating element 10 is used in a car seat heater or in a steering wheel heater, liquid given off by a passenger or a driver readily collects therein. Driving or riding for a long time becomes very uncomfortable.

On the other hand, in the case of the sheet heating element 30 of Patent Reference 3, the electrodes 32, 33, the polymer resistor 34, the substrate 31, and the cover layer 35 are flexible, so when used in a car seat heater or in a steering wheel heater, it is comfortable to sit or to feel the steering wheel. However, since the sheet heating element 30 is formed from six layers, there are the drawbacks that manufacturing productivity is low and cost is high.

Patent Reference 1: Japanese Patent Application Kokai Publication No. S56-13689

Patent Reference 2: Japanese Patent Application Kokai Publication No. H8-120182

Patent Reference 3: U.S. Pat. No. 7,049,559

### SUMMARY OF THE INVENTION

The present invention solves these problems of the prior art, and has as its object to provide a sheet heating element with excellent flexibility, durability, and reliability, as well as low manufacturing cost. When the sheet heating element of the present invention is used in a car seat heater or in a steering wheel heater, the passenger feels comfortable when seated, and the driver feels comfortable when touching the steering wheel.

The sheet heating element according to the present invention comprises a substrate sheet made of an electrically insulative material and lines made of electrically conductive materials and arranged with a distance between them on the substrate sheet. The sheet heating element further comprises at least one PTC resistor sheet being in electrical contact with the lines and configured to heat up in a self-regulated manner in response to a supply of electricity from the lines.

The at least one PTC resistor sheet may have a thickness of 20-200 micrometers or preferably 30-100 micrometers.

The at least one PTC resistor sheet may comprise a resin composition and a conductive material. The resin composition may comprise a reactant resin and a reactive resin which is cross-linked with the reactant resin. The conductive material may comprise at least one of carbon black and graphite. The at least one PTC resistor sheet may be thermally fusible to effect the electrical contact with the lines.

The at least one PTC resistor sheet may have an electric resistivity ranging between 0.0007 Ω·m and 0.016 Ω·m or preferably between 0.0011 Ω·m and 0.0078 Ω·m.

The at least one PTC resistor sheet may comprise a flame retardant agent. The flame retardant agent may comprise at least one of a phosphorus-based flame retardant, a nitrogen-based flame retardant, a silicone-based flame retardant, an inorganic flame retardant and a halogen-based flame retardant. The flame retardant agent is contained in the at least one PTC resistor sheet at a content of 5 wt. % or more, preferably 10-30 wt. % or optimally 5-25 wt. %. Due to inclusion of the frame retardant agent, the at least one PTC resistor sheet satisfies at least one of the following conditions:

(a) When an end of the at least one PTC resistor sheet is burned with a gas flame, and the gas flame is extinguished after 60 seconds, the at least one PTC resistor sheet does not burn, even if the at least one PTC resistor sheet is charred;

(b) When an end of the at least one PTC resistor sheet is burned with a gas flame, the at least one PTC resistor sheet catches fire for no more than 60 seconds, but the flame extinguishes within 2 inches; or

(c) When an end of the at least one PTC resistor sheet is burned with a gas flame, even if the at least one PTC resistor sheet catches fire, the flame does not advance at a rate of 4 inches/minute or more in an area ½ inch thick from the surface.

The at least one PTC resistor sheet may comprise a liquid-resistant resin. The liquid-resistant resin may comprise an ethylene/vinyl alcohol copolymer, a thermoplastic polyester resin, a polyamide resin, a polypropylene resin or an ionomer, or a combination thereof. The liquid-resistant resin is contained at a content of 10 wt. % or more in the at least one PTC resistor sheet, preferably 10-70 wt. % or optimally 30-50 wt. %.

The lines may be sewed onto the substrate sheet. The lines may have a diameter equal to or less than 1 mm, or preferably 0.5 mm and a resistivity equal to or less than 1 (Ω/m). The electrically conductive material which forms the lines may be copper, tin-plated copper, or a copper-silver alloy. The lines may be arranged at an interval of about 70-150 mm.

The at least one PTC resistor sheet may exhibit an elasticity higher than that of the substrate sheet and extend by more than 5% with a load of less than 7 kgf.

The substrate sheet may be made of either a non-woven or woven fabric formed from polyester fibers punched with a needle. The sheet heating element may further comprise a cover sheet made of an electrically insulative material and cooperative with the substrate sheet to enclose the lines and the at least one PTC resistor sheet. The cover sheet may be made of either a non-woven or woven fabric formed from polyester fibers. At least one of the substrate sheet and the cover sheet may comprise a flame retardant agent.

In the sheet heating element according to the present invention, the lines may be disposed between the at least one PTC resistor sheet and the substrate sheet. In the alternative, the at least one PTC resistor sheet is disposed between the lines and the substrate sheet.

The sheet heating element according to the present invention may further comprise a liquid-resistant film. The liquid-resistant film may comprise an ethylene/vinyl alcohol copolymer, a thermoplastic polyester resin, a polyamide resin, a polypropylene resin or an ionomer, or a combination thereof. The liquid-resistant film may have a thickness of 5-100 micrometers or preferably 10-50 micrometers. The liquid-resistant film is disposed between the at least one PTC resistor sheet and the substrate sheet. The liquid-resistant film may comprise a flame retardant agent.

At least one of the lines may run in a wavy manner. The lines may be arranged such that more than two lines supply electricity to each of the at least one PTC resistor sheet.

The sheet heating element according to the present invention may further comprise conductive films disposed between the lines and the at least one PTC resistor sheet which allow the lines to slide thereon. The conductive films may be made from graphite paste or a resin compound containing graphite.

The at least one PTC resistor sheet comprises a non-woven or woven fabric impregnated with a PTC resistor material.

The sheet heating element according to the present invention may further comprise a cover film made of thermoplastic elastomer. The cover film may be made of a polyolefin-based thermoplastic elastomer, a styrene-based thermoplastic elastomer, or a urethane-based thermoplastic elastomer, or a combination thereof.

At least one of the substrate sheet and the at least one PTC resistor sheet may be formed with a plurality of slits or a plurality of notch.

### BRIEF DESCRIPTION OF THE DRAWINGS

FIG. 1A is a transparent plan view of a prior art sheet heating element.

FIG. 1B is a sectional view of the sheet heating element shown in FIG. 1A.

FIG. 2 is an abbreviated sectional view of an example of the structure of a manufacturing device of a prior art sheet heating element.

FIG. 3 is a sectional view of another prior art sheet heating element.

FIG. 4A is a plan view of a sheet heat element of Embodiment 1 of the present invention.

FIG. 4B is a sectional view of the sheet heating element shown in FIG. 4A.

FIG. 4C is a sectional view of a first modified embodiment of the sheet heating element shown in FIG. 4A.

FIG. 4D is a sectional view of a second modified embodiment of the sheet heating element shown in FIG. 4A.

FIG. 5A is a transparent lateral view of a car seat to which is attached a sheet heating element of Embodiment 1 of the present invention.

FIG. 5B is a transparent frontal view of the seat shown in FIG. 5A.

FIG. 6A and FIG. 6B are drawings of Embodiment 1 of a polymer resistor used in the present invention.

FIG. 6C and FIG. 6D are drawings of Embodiment 2 of a polymer resistor used in the present invention.

FIG. 7A is a plan view of a sheet heating element of Embodiment 2 of the present invention.

FIG. 7B is a sectional view of the sheet heating element shown in FIG. 12A.

FIG. 7C is a sectional view of a first modified embodiment of the sheet heating element shown in FIG. 7A.

FIG. 7D is a sectional view of a second modified embodiment of the sheet heating element shown in FIG. 7A.

FIG. 8A is a plan view of a sheet heating element of Embodiment 3 of the present invention.

FIG. 8B is a sectional view of the sheet heating element shown in FIG. 8A.

FIG. 8C is a sectional view of a first modified embodiment of the sheet heating element shown in FIG. 8A.

FIG. 8D is a sectional view of a second modified embodiment of the sheet heating element shown in FIG. 8A.

FIG. 9A is a plan view of a sheet heating element of Embodiment 4 of the present invention.

FIG. 9B is a sectional view of the sheet heating element shown in FIG. 14A.

FIG. 9C is a sectional view of a first modified embodiment of the sheet heating element shown in FIG. 9A.

FIG. 9D is a sectional view of a second modified embodiment of the sheet heating element shown in FIG. 9A.

FIG. 10A is a plan view of a sheet heating element of Embodiment 5 of the present invention.

FIG. 10B is a sectional view of the sheet heating element shown in FIG. 10A.

FIG. 10C is a sectional view of a first modified embodiment of the sheet heating element shown in FIG. 10A.

FIG. 10D is a sectional view of a second modified embodiment of the sheet heating element shown in FIG. 10A.

FIG. 11A is a plan view of a sheet heating element of Embodiment 6 of the present invention.

FIG. 11B is a sectional view of the sheet heating element shown in FIG. 11A.

FIG. 11C is a sectional view of a first modified embodiment of the sheet heating element shown in FIG. 11A.

FIG. 11D is a sectional view of a second modified embodiment of the sheet heating element shown in FIG. 11A.

FIG. 12A is a plan view of a sheet heating element of Embodiment 7 of the present invention.

FIG. 12B is a sectional view of the sheet heating element shown in FIG. 17A.

FIG. 12C is a sectional view of a first modified embodiment of the sheet heating element shown in FIG. 12A.

FIG. 13A is a plan view of a sheet heating element of Embodiment 8 of the present invention.

FIG. 13B is a sectional view of the sheet heating element shown in FIG. 13A.

FIG. 13C is a sectional view of a first modified embodiment of the sheet heating element shown in FIG. 13A.

FIG. 13D is a sectional view of a second modified embodiment of the sheet heating element shown in FIG. 13A.

FIG. 14A is a plan view of a sheet heating element of Embodiment 9 of the present invention.

FIG. 14B is a sectional view of the sheet heating element shown in FIG. 19A.

FIG. 14C is a sectional view of a first modified embodiment of the sheet heating element shown in FIG. 14A.

FIG. 14D is a sectional view of a second modified embodiment of the sheet heating element shown in FIG. 14A.

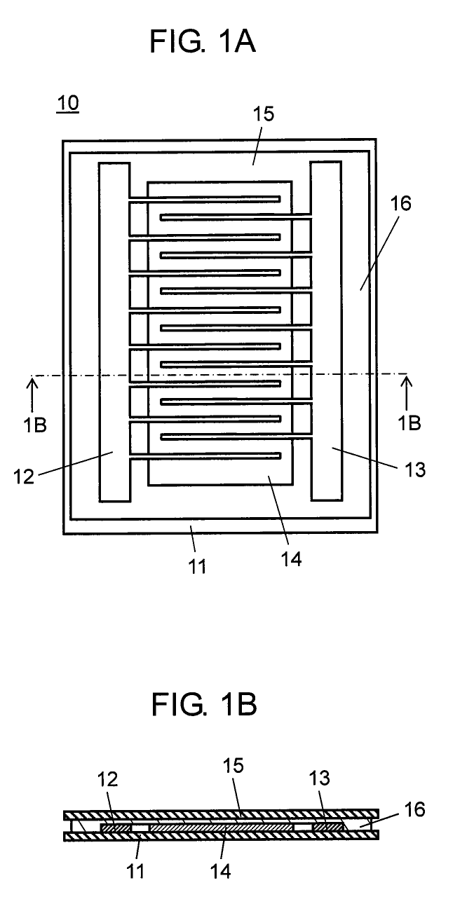

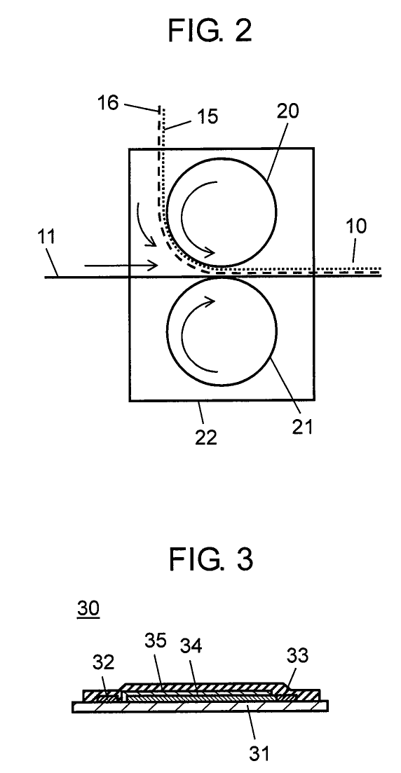

### DETAILED DESCRIPTION OF THE PREFERRED EMBODIMENTS

Embodiments of the present invention are described below with reference to the drawings. It should be noted that the present invention is not limited to these embodiments. Moreover, structures particular to the various embodiments can be suitably combined.

### Embodiment 1 of a Sheet Heating Element

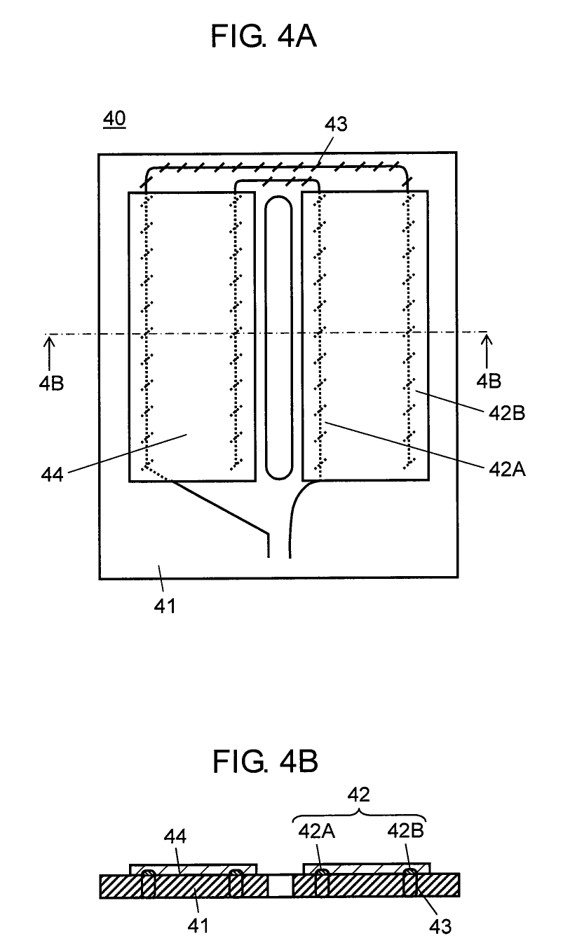

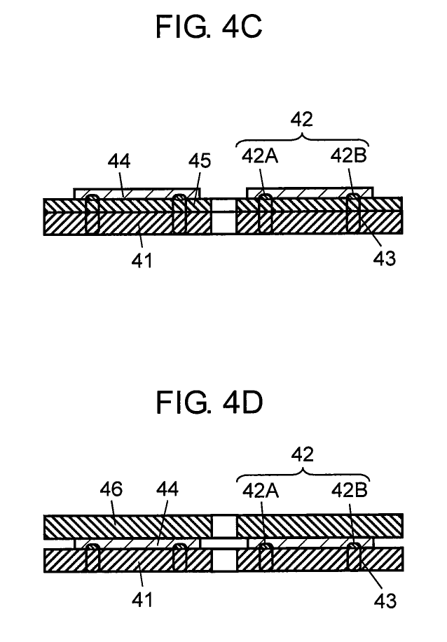

Following is a description of an embodiment of a sheet heating element using the above-described polymer resistor. FIG. 4A is a plan view of Embodiment 1 of the sheet heat element of the present invention, and FIG. 4B is a sectional view of the sheet heating element of FIG. 4A along the line 4B-4B.

A sheet heating element 40 includes an insulating substrate 41, a first line electrode 42A, a second line electrode 42B, and a polymer resistor 44. The line electrodes 42A, 42B are sometimes referred together as line electrodes 42. The line electrodes 42 are sewn onto the insulating substrate 41 with a thread 43. The polymer resistor 44 is thermally adhered on top of this in the form of a film.

The sheet heating element 40 is produced in the following manner. First, the line electrodes 42A, 42B are disposed right-left symmetrically on the insulating substrate 41. Next, the line electrodes 42A, 42B are partially sewn onto the insulating substrate 41 with the thread 43. Then, using a T-die extruder, for example, the polymer resistor 44 is extruded as a film onto the insulating substrate 41. After that, the polymer resistor 44 is melt-adhered with a laminator and attached to the insulating substrate 41.

There are no particular restrictions on the thickness of the polymer resistor 44, but when flexibility, materials cost, appropriate resistance value, and strength when a load is applied are taken into consideration, a thickness of 20-200 micrometers is suitable, and preferably 30-100 micrometers.

After the polymer resistor 44 is melt-adhered to the line electrodes 42 and the insulating substrate 41, the central portion of the sheet heating element is punched. The position where the central portion is punched is not limited to the position shown in the drawing. There are cases in which the punching of the central portion is in other positions, depending on the application. In order to avoid punching, the wiring pattern of the line electrodes 42 must be modified.

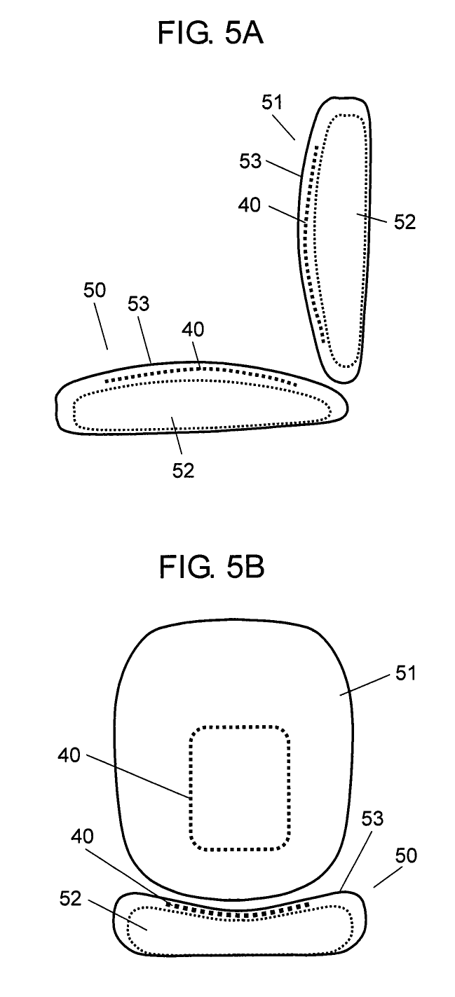

The above-described sheet heating element 40 is used, for example, in a car seat heater. In this case, as shown in FIGS. 5A and 5B, the sheet heating element 40 is attached to the inside of a seat part 50 and to a back rest 51 provided in a manner so as to rise from the seat part 50. The seat part 50 and the back rest 51 have a seat base material 52 and a seat cover 53 covering the seat base material 52. The seat base material 52 is formed from a flexible material such as a urethane pad, and changes shape when a load is applied by a seated person, and regains its original shape when the load is removed. The sheet heating element 40 is attached with the polymer resistor 44 side facing the seat base material 52 and with the insulating substrate 41 facing the seat cover 53.

Since the sheet heating element 40 has a PTC characteristic, there is little energy consumed, since the temperature rises rapidly. A heating element without a PTC characteristic must additionally have a temperature controller. This additional temperature controller controls the heating temperature by turning the current on and off. In particular, when a heating element has line heat rays, there are several low-temperature sites between the linear heat rays. In order to reduce these low-temperature sites as much as possible, in the case of a heating element without a PTC characteristic, the heating temperature is raised to about 80° C. when ON. Thus, a heating element without a PTC characteristic must be disposed within a seat at a depth some distant from the seat cover 53.

By contrast, in the case of the sheet heating element 40, which has a PTC characteristic, the heating temperature is automatically controlled so as to be in the range of 40° C.-45° C. Since the heating temperature is kept low in such a sheet heating element 40, it can be disposed close to the seat cover 53. Furthermore, since the heating element is disposed near the seat cover 53, it can rapidly convey heat to a seated passenger. Moreover, since the heating temperature is kept low, the energy consumption can be reduced.

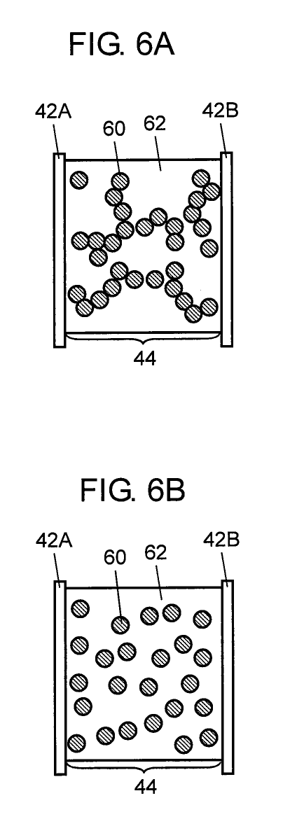

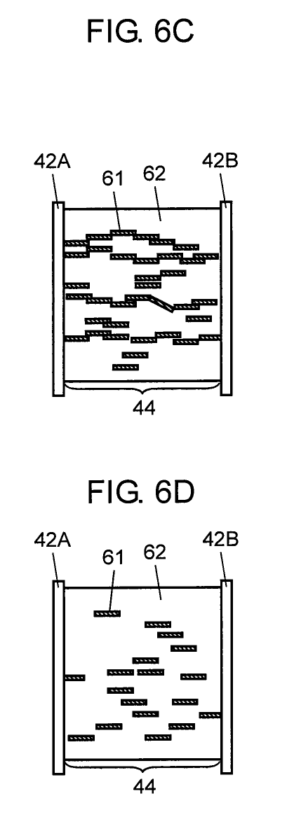

Next is a further description of the detailed structure of the sheet heating element 43 of the present invention. FIGS. 6A-6D show examples of a polymer resistor 44 used in a sheet heating element of the present invention. FIGS. 6A and 6B show a polymer resistor 44 using particulate conductors such as carbon black. FIGS. 6C and 6D show a polymer resistor using fibrous conductors. FIGS. 6A and 6C show the internal state of the polymer resistors 44 at a room temperature. FIGS. 6C and 6D show the internal state when the temperature rises from the state shown in FIGS. 6A and 6B.

The polymer resistor 44 shown in FIGS. 6A and 6B has particulate conductors 60 such as carbon black. The particulate conductors 60 make point contact in a resin composition 62, forming conductive passes. When current is applied across the electrodes 42A, 42B, current flows through the particulate conductors 60, so that the polymer resistor 44 heats up. The resin composition 62 expands, as the polymer resistor 44 heats up. Thus, as shown in FIG. 6B, the conductive passes created by the particulate conductors 60 are cut off. As a result, the resistivity of the polymer resistor 44 dramatically increases.

The polymer resistor 44 shown in FIGS. 6C and 6D use fibrous conductors 61 as conductors. These fibrous conductors 61 are placed on top of each other lengthwise within the resin composition 62, forming conductive passes. When current is applied across the electrodes 42A, 42B, this polymer resistor 44 also heats up, and as it heats up, the resistivity of the polymer resistor 44 dramatically increases.

Examples of fibrous conductors 61 include conductive ceramic fibers made from tin-plated and antimony-doped titanium oxide, potassium titanate-based conductive ceramic whiskers, copper or aluminum metallic fibers, metal-plated glass fibers with conductive layers formed on their surfaces, carbon fibers, carbon nanotubes, or fibrous conductive polymers formed from polyaniline and the like. Moreover, a flake conductor can be used instead of the fibrous conductor 61. Examples of a flake conductor include ceramic flakes such as mica flakes with conductive layers formed on their surfaces, metallic flakes of copper or aluminum and the like, or flake graphite.

The above conductors can be used individually or in mixtures of 2 or more kinds, and suitably selected, given the desired PTC characteristic.

The resin composition 62 of the polymer resistor 44 is formed by blending a reactant resin which exhibits a PTC characteristic, and a reactive resin which reacts with this reactant resin. The reactant resin is preferably a modified polyethylene having a carboxyl group. The reactive resin is preferably a modified polyethylene having an epoxy group. By blending these together, the carboxyl groups in the reactant resin chemically bond with the oxygen of the epoxy groups in the reactive resin, so that the polymer resistor has a cross-linked structure within it.

Due to this cross-linked structure, the temperature characteristics of the thermal expansion ratio and melting temperature characteristics of the polymer resistor 44 are more stable than in the case where the resin composition 62 is formed by a reactant resin alone. Since the reactive resin and the reactant resin bond firmly due to the cross-linked structure, even under repeated cooling and heating, resulting in repeated thermal expansion and thermal contraction, the temperature characteristics of the thermal expansion ratio and the melting temperature characteristics of the polymer resistor are maintained, so that variation thereof with the passage of time is suppressed. In other words, even as time passes, the polymer resistor 44 maintains constant temperature characteristics of the thermal expansion ratio and constant melting temperature characteristics.

This cross-linking reaction can occur via nitrogen in addition to oxygen. A cross-linking reaction occurs if a reactive resin containing a functional group containing at least either oxygen or nitrogen and a reactant resin possessing a functional group capable of reacting with the functional group are blended by kneading. Examples of functional groups of the reactive resin and functional groups of the reactant resin other than the above-described epoxy groups and carbonyl groups, are given below.

Examples of functional groups of the reactant resin, other than carbonyl groups, include epoxy groups, carboxyl groups, ester groups, hydroxyl groups, amino groups, vinyl groups, maleic anhydride groups, and oxazoline groups in addition polymerization. Examples of functional groups of the reactive resin, other than epoxy groups, include oxazoline groups and maleic anhydride groups.

Since a car seat heater is required to heat up at a relatively low heating temperature of 40-50° C., the reactant resin exhibiting a PTC characteristic can preferably be a low-melting point modified olefinic resin such as ethylene/vinyl acetate copolymer, ethylene/ethyl acrylate copolymer, ethylene/methyl methacrylate copolymer, ethylene/methacrylic acid copolymer, ethylene/butyl acrylate copolymer, or other ester-type ethylene copolymer.

It is not necessarily required to prepare the resin composition 62 by blending the reactant resin and the reactive resin by kneading. A PTC characteristic can be exhibited even if the reactant resin is used by itself. Therefore, if change over time in the PTC characteristic is allowed to some degree, the reactant resin can be used by itself. When the reactant resin is used by itself, the type of reactant resin will be suitably selected according to the desired PTC characteristic value.

In the above description, the reactive resin and the reactant resin are reacted so as to impart a cross-linked structure to the reactant resin of the resin composition 62. However, a cross-linking agent can be used that differs from the reactive resin. Moreover, it is also possible to form a cross-linked structure in the reactant resin without using a reactive resin, but instead, by irradiating the reactant resin with an electron beam. In this case, it is possible to use a reactant resin which does not have the above-mentioned functional groups.

Since the polymer resistor 44 is a flexible film, it stretches and changes its shape in the same manner as the insulating substrate 41 when an external force is applied to the sheet heating element 40. The polymer resistor 44 should be either as flexible as or more flexible than the insulating substrate 41. If the polymer resistor 44 is as flexible as or more flexible than the insulating substrate 41, then the durability and reliability of the polymer resistor 44 increases because the insulating substrate 41 has greater mechanical strength than the polymer resistor 44 and, when an external force is applied, serves to restrict a stretch or change of the shape of the polymer resistor 44.

If the polymer resistor 40 is used in a car seat heater, it is even more advantageous for the polymer resistor 44 to contain a flame retardant agent. A car seat heater must satisfy the flammability standard of U.S. FMVSS 302. Specifically, it must satisfy any one of the conditions given below.
(1) When an end of the polymer resistor 44 is burned with a gas flame, and the gas flame is extinguished after 60 seconds, the polymer resistor 44 itself does not burn, even if the polymer resistor 44 is charred.
(2) When an end of the polymer resistor 44 is burned with a gas flame, the polymer resistor 44 catches fire for no more than 60 seconds, but the flame extinguishes within 2 inches.
(3) When an end of the polymer resistor 44 is burned with a gas flame, even if the polymer resistor 44 catches fire, the flame does not advance at a rate of 4 inches/minute or more in an area ½ inch thick from the surface.

Incombustibility is defined as follows. An end of a specimen is burned for 60 seconds with a gas flame. When the flame is extinguished after 60 seconds, the specimen does not burn even though charred remnants remain on the specimen. Self-extinguishing refers to a specimen catching fire for no more 60 seconds, and the burned portion is within 2 inches.

The flame retardant agent can be a phosphorus-based flame retardant such as ammonium phosphate or tricresyl phosphate; a nitrogen-based compound such as melamine, guanidine, or guanylurea; or a silicone-based compound; or a combination of these. An inorganic flame retardant such as magnesium oxide or antimony trioxide, or a halogen-based flame retardant such as a bromine-based or chlorine-based compound can be used.

It is particularly advantageous if the flame retardant agent is a liquid at room temperatures, or has a melting point such that it melts at the mixing temperature. The flexibility of the polymer resistor 44 can be increased by using at least one type of phosphorus-based, ammonium-based, or silicone-based compound, thereby enhancing the mechanical durability and reliability of the sheet heating element.

The amount of flame retardant agent added is determined as follows. If there is little flame retardant agent, the incombustibility becomes poor, and any of the above conditions for incombustibility are not satisfied. In view of this, the amount of flame retardant agent to be added should be 5 wt. % or more with respect to the polymer resistor 44. However, when the amount of flame retardant agent increases, the compositional balance between the resin composition 62 and the conductor 60 or the conductor 61 contained therein becomes poor, the resistivity of the polymer resistor 44 increases, and the PTC characteristic becomes poor. In view of this, the amount of added flame retardant agent is preferably 10-30 wt. %, and optimally 15-25 wt. %, with respect to the polymer resistor 44.

It is advantageous to add a liquid-resistant resin to the polymer resistor 44, so as to impart liquid resistance. Liquid resistance prevents the polymer resistor 44 from deterioration due to contact with liquid chemicals such inorganic oils including engine oil, polar oils such as brake oil, and other oils, or low-molecular weight solvents such as thinners and other organic solvents.

When the polymer resistor 44 comes into contact with the above liquid chemicals, the resin composition 62 which contains large quantities of amorphous resin, readily expands and the volume changes, so that the conductive passes of the conductors are broken and the resistance rises. This phenomenon is identical to changes in volume (or PTC characteristic) due to heat. When the polymer resistor 44 comes into contact with a liquid chemical described above, the initial resistance value is not recovered, even if the liquid dries. Even if it is recovered, the recovery takes time.

In order to impart liquid resistance to the polymer resistor 44, a highly crystallized liquid-resistant resin is added to the polymer resistor 44 so that the resin composition 62 and the conductors 60, 61 are partially chemically bonded to the liquid-resistant resin. As a result, even if the polymer resistor 44 comes into contact with a liquid chemical described above, expansion of the resin composition 62 is inhibited.

The liquid-resistant resin contains one species selected from an ethylene/vinyl alcohol copolymer, a thermoplastic polyester resin, a polyamide resin, a polypropylene resin, or an ionomer, or can use a combination thereof. These liquid-resistant resins not only impart liquid resistance to the polymer resistor 44, but they also function to prevent a decrease in flexibility of the resin composition 62. In other words, these liquid-resistant resins support the flexibility of the polymer resistor 44.

The amount of liquid-resistant resin added is preferably 10 wt. % or more with respect to the resin composition 62 in the polymer resistor 44. Thereby, the liquid resistance of the polymer resistor 44 increases. However, when there is a large amount of liquid-resistant resin, the polymer resistor 44 itself will harden, and its flexibility will decrease. Also, the conductors will be captured within the liquid-resistant resin, and the conductive passes will hardly be cut off even when the temperature rises, and the PTC characteristic will eventually drop. Therefore, in order to support the flexibility of the polymer resistor, and to maintain a favorable PTC characteristic, the amount of liquid-resistant resin is preferably in the range of 10-70 wt. %, and optimally 30-50 wt. %.

The following test was conducted to investigate the effects of the liquid-resistant resins described above. First, a polymer resistor 44 was prepared without containing a liquid-resistant resin, and a plurality of polymer resistors 44 were prepared containing respectively differing liquid-resistant resins (50 wt. %). The above-mentioned liquid chemical was dripped onto these polymer resistors 44 and they were allowed to stand for 24 hours. After applying an electric current to these polymer resisters 44 for 24 hours, they were allowed to stand at room temperature for 24 hours. The resistivity values of these polymer resistors were measured before and after the test. It was found that polymer resistors 44 which did not contain a liquid-resistant resin showed a 200-300-fold increase in resistivity as compared to before the test.

By contrast, in all of the polymer resistors 44 which contained liquid-resistant resins, the increase in resistivity was no more than 1.5-3-fold as compared to before the test. This test showed that adding a liquid-resistant resin to the polymer resistor 44 makes it possible to inhibit the expansion of the resin composition 62 forming the polymer resistor 44 which may be caused by contact with a liquid chemical such as organic solvents or beverages. In other words, the resistivity of the polymer resistor 44 can be stabilized, and the sheet heating element can have a high level of durability, by adding a liquid-resistant resin to the polymer resistor 44.

The pair of line electrodes 42A, 42B which are disposed facing each other are provided in two rows in the longitudinal direction of the sheet heating element 40. The polymer resistor 44 is arranged so as to overlap on the pair of line electrodes 42A, 42B, respectively. When electricity is supplied from the line electrodes 42A, 42B to the polymer resistor 44, current flows to the polymer resistor 44, and the polymer resistor 44 heats up.

The line electrodes 42 are sewn with a sewing machine onto the insulating substrate 41 with a polyester thread 43. Thus, the line electrodes 42 are firmly affixed to the insulating substrate 41, enabling it to change its shape as the insulating substrate 41 changes the shape, thereby increasing the mechanical reliability of the sheet heating element.

The line electrodes 42 are formed from at least either a metallic conductor wire and/or a twisted metallic conductor wires in which metallic conductor wires are twisted together. The metallic conductor wire material can be copper, tin-plated copper, or a copper-silver alloy. From the standpoint of mechanical strength, it is advantageous to use a copper-silver alloy because it has a high tensile strength. In detail, the line electrodes 42 are formed by twisting together 19 copper-silver alloy wires with a diameter of 0.05 micrometers.

The resistance of the line electrodes 42 should be as low as possible, and the voltage drop along the line electrodes 42 should be small. The resistance of the line electrodes 42 is selected so that the voltage drop of the voltage applied to the sheet heating element is 1 V or less. In other words, it is advantageous for the resistivity of the line electrodes 42 to be 1 Ω/m or lower. If the diameter of the line electrodes 42 is large, it forms bumps in the sheet heating element 44, resulting in a loss of comfort when seated thereon. So the diameter should be 1 mm or less, and a diameter of 0.5 mm or less is desirable for an even more comfortable feeling when seated thereon.

A distance between the line electrodes 42A, 42B should be in the range of about 70-150 mm. For practical purposes, the distance between the line electrodes 42A, 42B should be about 100 mm. If the distance between the electrodes is less than about 70 mm, when a person sits on the sheet heating element 44, and the buttocks are pressed on the line electrodes 42, there is a possibility that the load and flexural force will cause the line electrodes 42 to break or become damaged. On the other hand, if the distance between the electrodes is greater than 150 mm, the resistivity of the polymer resistor 44 must be reduced to a very low level, making it difficult to produce a useful polymer resistor 44 which has a PTC characteristic.

If the distance between the line electrodes 42A, 42B is 70 mm, since the film thickness of the polymer resistor 44 is 20-200 micrometers as mentioned above, and preferably 30-100 micrometers, the resistivity of the polymer resistor 44 should be in the range of about 0.0016-0.016 Ω/m, and preferably about 0.0023-0.0078 Ω/m. Furthermore, if the distance between the line electrodes 42A, 42B is 100 mm, the resistivity of the polymer resistor 44 should be in the range of about 0.0011-0.011 Ω/m, and preferably about 0.0016-0.0055 Ω/m. Moreover, if the distance between the line electrodes 42A, 42B is 150 mm, the resistivity of the polymer resistor 44 should be in the range of about 0.0007-0.007 Ω/m, and preferably about 0.0011-0.0036 Ω/m.

It should be noted that in this embodiment, a line electrode is used as the electrode, but the present invention is not restricted thereto, and it is also possible to use a metallic foil electrode, or an electrode membrane produced by screen printing of a silver paste or the like.

A non-woven fabric formed from polyester fibers, punched using a needle punch, can be used for the insulating substrate 41. A woven fabric formed from polyester fibers can also be used. The insulating substrate 41 imparts flexibility to the sheet heating element 44. The sheet heating element 44 can easily change its shape if an external force is applied. So if it is used in a car seat heater, the feeling of comfort when seated thereon is improved. The sheet heating element has the same elongation properties as the seat cover material. Specifically, under a load of 7 kgf or less, it stretches by 5% at maximum.

As mentioned above, the line electrodes 42 are sewn onto the insulating substrate 41. Because of sewing, needle holes are formed in the insulating substrate 41, but the above-mentioned non-woven fabric or woven fabric can prevent cracks from developing from the needle holes.

Non-woven or woven fabrics of polyester fibers have good ventilation properties, and when used as a car seat heater or steering wheel heater, moisture will not collect. Thus, even if seated thereon or gripped for a long period of time, the initial comfortable feel is maintained, and is very pleasant. And since no sound like sitting on paper is made when a passenger sits, the seat does not lose its comfortable feel even with the sheet heating element 40 placed inside

Moreover, it is desirable to impart incombustibility by impregnating the insulating substrate 42 with an above-described flame retardant agent. The amount of flame retardant agent added should be 5 wt. % or more with respect to the insulating substrate 41. However, when the amount of added flame retardant agent increases, the cost of manufacturing the sheet heating element 40 goes up. In addition, the physical properties of the insulating substrate 41 become poor. In view of this, the amount of added flame retardant agent is preferably 10-30 wt. %, and optimally 15-25 wt. %, with respect to the insulating substrate 41.

The sheet heating element can also have a liquid-resistant film 45 of the type shown in FIG. 4C. The liquid-resistant film 45 is adhered to the insulating substrate 41. The sheet heating element 40 shown in FIG. 4C is produced in the following manner. First, using T-die extrusion, for example, a liquid-resistant resin is extruded in the form of a film onto the insulating substrate 41, forming the liquid-resistant film 45. The line electrodes 42A, 42B are then arranged on the liquid-resistant film 45, and sewn onto the insulating substrate 41 and the liquid-resistant film 45, using the thread 43. Then, T-die extrusion is used to extrude a polymer resistor 44 in a film form onto the liquid-resistant film 45. The polymer resistor 44 thermally adheres the line electrodes 42 to the liquid-resistant film 45.

The sheet heating element 40 is affixed so that the insulating substrate 41 will make contact a place where liquid chemicals can permeate. Thus, even if liquid chemicals permeate to the insulating substrate 41, it is protected by the liquid-resistant film 45, and the chemicals do not reach the polymer resistor 44. In other words, the liquid-resistant film 45 prevents contact between chemicals and the polymer resistor 44. If the sheet heating element is provided with the liquid-resistant film 45, then the polymer resistor 44 does not need to have liquid resistant properties.

The material of the liquid-resistant film 45 can be an ethylene/vinyl alcohol copolymer, a thermoplastic polyester resin, a polyamide resin, a polypropylene resin, or an ionomer, used singly or in combination.

From the standpoint of flexibility of the sheet heating element 40, the liquid-resistant film 45 should be thin, but in order to achieve liquid resistance properties, the thickness should be in the range of 5-100 micrometers. Given the manufacturing productivity and cost, a thickness of 10-50 micrometers is optimal.

Furthermore, the above-described flame retardant agents can be added to the liquid-resistant film 45. The amount of added flame retardant agent is preferably 10-30 wt. %, and optimally 15-25 wt. %, with respect to the liquid-resistant film 45.

Moreover, the sheet heating element can be provided with a second insulating substrate 46 of the type shown in FIG. 4D. The sheet heating element of FIG. 4D is produced in the following manner. First, the line electrodes 42A, 42B are disposed right-left symmetrically on a first insulating substrate 41, and are respectively partially sewn thereon with the thread 43. Then, using T-die extrusion to extrude a film, the polymer resistor 44 is formed on the second insulating substrate 46. The first insulating substrate 41 and the second insulating substrate 46 are then joined together by thermal adhesion, using a device such as a laminator, so that the line electrodes 42 and the polymer resistor 44 come into contact.

The second insulating substrate 46 is formed with the same materials and specifications as the first insulating substrate 41. The second insulating substrate 46 can also be impregnated with an above-described flame retardant agent. The amount of flame retardant agent added must be 5 wt. % or more with respect to the insulating substrate 46, preferably 10-30 wt. %, and optimally 15-25 wt. %.

Due to the fact that both sides of the sheet heating element 40 are covered by the first insulating substrate 41 and the second insulating substrate 46, respectively, the cushioning effect of the sheet heating element 40 itself increases. Thus, if used in a car seat heater, there is an enhanced feeling of comfort when seated thereon. Furthermore, the second insulating substrate 46 protects the polymer resistor 44 from impact and scratching.

In addition, when the heating element is used in a car heater or such conditions as subjecting the heating element to a constant external force consisting of sliding, the second insulating substrate 46 prevents abrasion of and damage to the polymer resistor 44. Since the polymer resistor 44 is covered entirely by two insulating substrates, the electrical insulation properties of the sheet heating element are enhanced.

Also, the heating element 40 shown in FIG. 4C may have the second insulating substrate 46.

### Embodiment 2 of a Sheet Heating Element

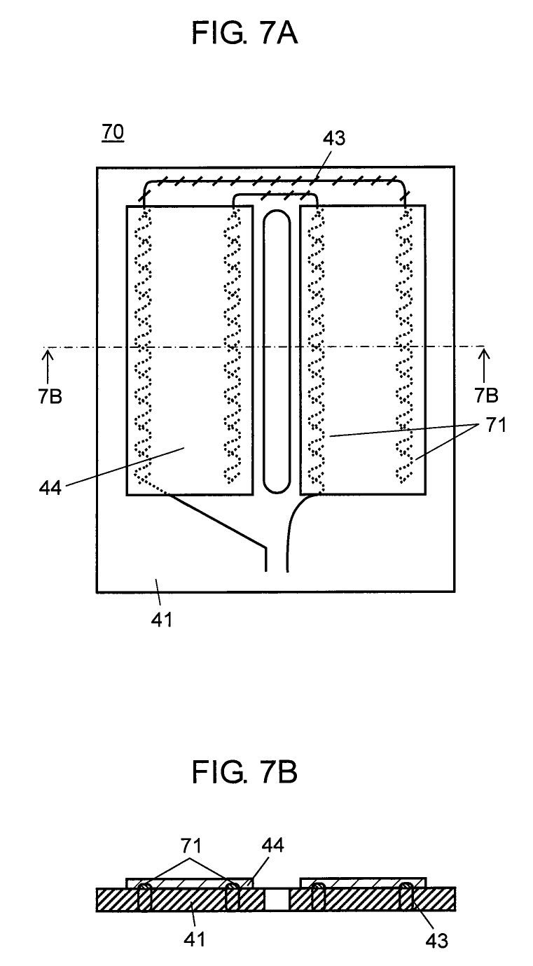

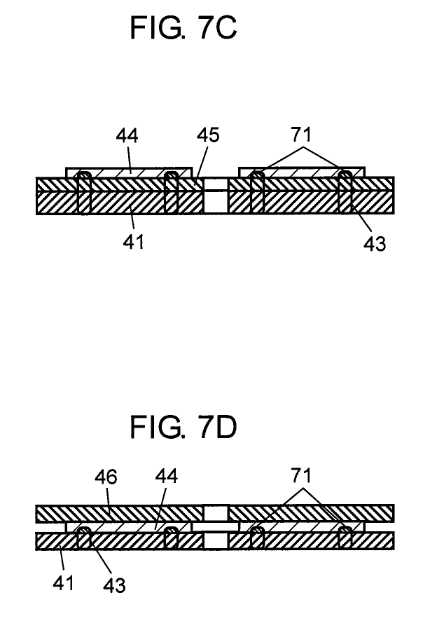

FIG. 7A is a plan view of the sheet heating element 70 of Embodiment 2 of the present invention, and FIG. 7B is a sectional view along the line 7B-7B in FIG. 7A. The structure differs from that of Embodiment 1 (see FIG. 4A) in that line electrodes 71 are arranged in wavy lines on the insulating substrate 41.

As shown in FIG. 7A, the line electrodes 71 are arranged in wavy lines on the insulating substrate 41, being attached by the thread 43. In accordance with this structure, when an external force is applied to the sheet heating element 70, since the line electrodes 71 are arranged in wavy lines, having leeway in terms of length, they readily change the shape in response to tension, stretching, and bending. Therefore, the wave line electrodes 71 have mechanical strength with respect to external force superior to that of the line electrodes 42 arranged in straight lines as shown in FIG. 4A.

Furthermore, in regions where the wave line electrodes 71 run, the voltage applied to the polymer resistor 44 becomes uniform, and the heating temperature distribution of the polymer resistor 44 becomes uniform.

Moreover, the sheet heating element 70 can have the liquid-resistant film 45 described in Embodiment 1 (see FIG. 7C). The wave line electrodes 71 are sewn onto the liquid-resistant film 45 on the insulating substrate 41, using the thread 43.

In addition, the sheet heating element can have the second insulating substrate 46 described in Embodiment 1 (see FIG. 7D). The sheet heating element 70 covered by the second insulating substrate 46 as shown in FIG. 7D can also have a liquid-resistant film shown in FIG. 7C.

### Embodiment 3 of a Sheet Heating Element

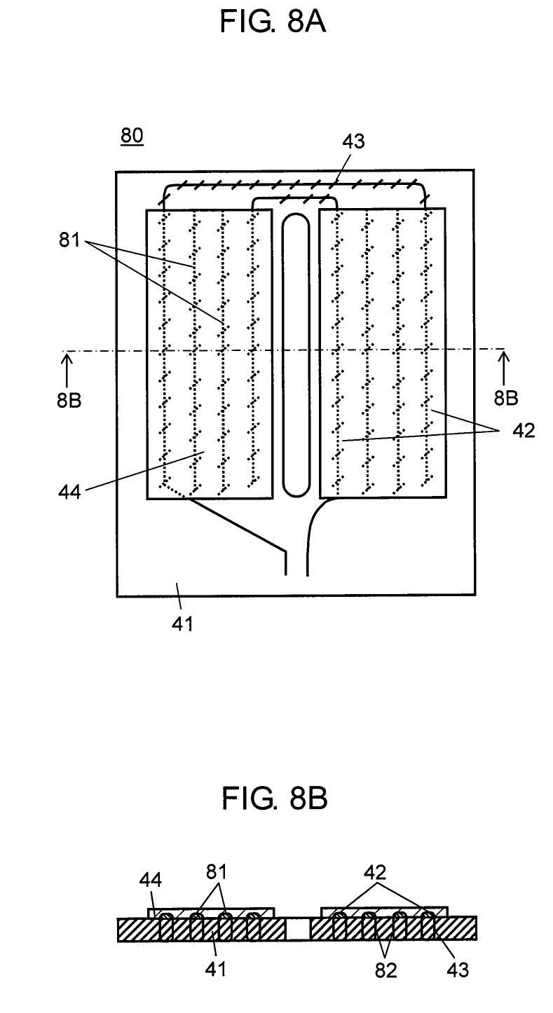

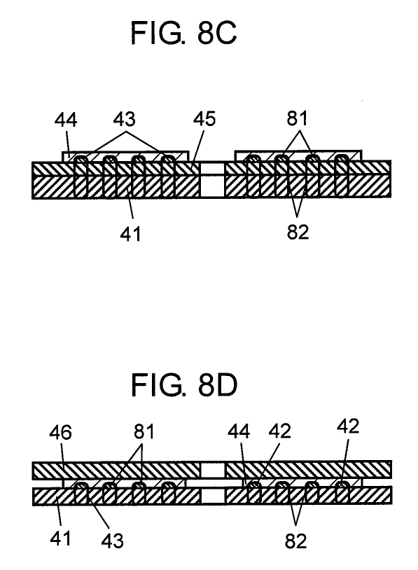

FIG. 8A is a plan view of a sheet heating element of Embodiment 3 of the present invention, and FIG. 8B is a sectional view along the line 8B-8B in FIG. 8A. The structure differs from that of Embodiment 1 (see FIG. 4A) in that auxiliary line electrodes 81 are arranged between the pair of line electrodes 42. In other words, auxiliary line electrodes 81 are arranged between the pair of line electrodes 42, and are sewn onto the insulating substrate 41 by sewing machine, using a thread 82 made of polyester fibers or the like, as in the case of the line electrodes 42.

In the structure shown in FIG. 4A, the polymer resistor 44 is prone to unevenly heats up between the line electrodes 42, and the resistivity for that portion rises, concentrating the electric potential there. If this state continues, the temperature of that part of the polymer resistor 44 increases more than other parts, resulting in what is known as the hot-line phenomenon. By providing the auxiliary line electrodes 81 as in FIG. 8A, the electrical potential becomes uniform throughout the entire polymer resistor 44, so that the heating temperature becomes uniform. Consequently, the hot-line phenomenon can be prevented from occurring in a part of the polymer resistor 44.

It should be noted that, like the line electrodes 42, the auxiliary line electrodes 81 are formed from a metallic conductor or twisted metallic conductors.

In FIG. 8A and FIG. 8B, two auxiliary line electrodes 81 are arranged between the pair of line electrodes 42. But the number of auxiliary line electrodes 81 is not restricted thereto, and the number can be determined according to the size of the polymer resistor 44, the distance between the line electrodes 42, and the required heat distribution.

In FIG. 8A, the auxiliary line electrodes 81 are arranged almost parallel to the pair of line electrodes 42. But the arrangement is not restricted thereto, and the auxiliary line electrodes 81 can also be arranged in a zig-zag configuration between the pair of line electrodes 42.

Moreover, the auxiliary line electrodes 81 can be arranged in a wavy configuration like the line electrodes 71 of Embodiment 2 shown in FIGS. 7A and 7B. Of course, wave-shaped line electrodes 71 and wave-shaped auxiliary line electrodes 81 can be combined.

The sheet heating element 80 can have the liquid-resistant film 45 described in Embodiment 1 (see FIG. 8C). The line electrodes 42 and the auxiliary line electrodes 81 are sewn onto the liquid-resistant film 45 and to the insulating substrate 41 with the threads 43, 82.

In addition, the sheet heat element 80 can have the second insulating substrate 46 described in Embodiment 1 (see FIG. 8D). The configuration can also have the liquid-resistant film 45 shown in FIG. 8C as well as the second insulating substrate shown in FIG. 8D.

### Embodiment 4 of a Sheet Heating Element

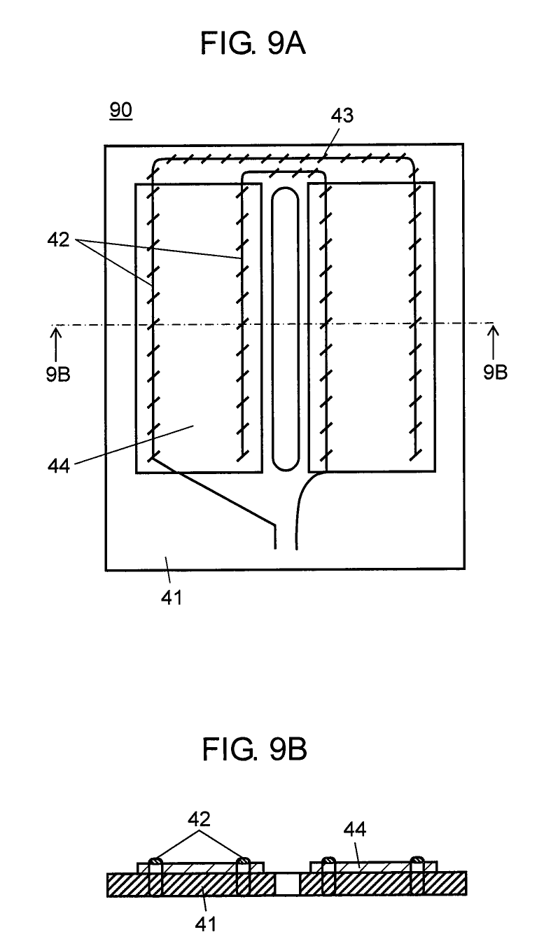

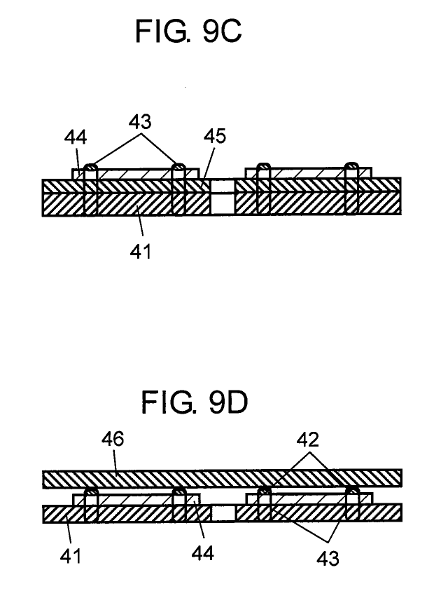

FIG. 9A is a plan view of a sheet heating element 90 of Embodiment 4 of the present invention. FIG. 9B is a sectional view along the line 9B-9B in FIG. 9A. The structure differs from that of Embodiment 1 (see FIG. 4A) in that the polymer resistor 44 is disposed by inserting it between the insulating substrate 41 and the line electrodes 42.

The sheet heating element 90 of Embodiment 4 is produced as follows. First, the polymer resistor 44 is heat-laminated as a film on the insulating substrate 41. Then, the line electrodes 42 are arranged on the polymer resistor 44, and sewn by sewing machine on the insulating substrate 41. The line electrodes 42 and the polymer resistor 44 are subjected to thermal compression treatment, so that the line electrodes 42 adhere to the polymer resistor 44. Since the line electrodes 42 are on the polymer resistor 44, the arrangement position of the line electrodes 42 can be easily verified. When the central portion of the insulating substrate 41 is punched so as to increase the flexibility, punching of the line electrodes 42 can be reliably avoided.

Furthermore, since the line electrodes 42 are sewn onto the insulating substrate 41 to which the polymer resistor 44 has been attached, there is a greater degree of freedom in arranging the line electrodes 42. A variety of different sheet heating elements 90 can be easily produced by making the process of attaching the polymer resistor 44 to the insulating substrate 41 a shared process, after which the line electrodes 42 can be sewn in a variety of arrangements to have a variety of heating patterns.

Moreover, in this embodiment, it is also possible to provide the auxiliary line electrodes 81 shown in FIG. 8A.

In this embodiment, the line electrodes 42 and the polymer resistor 44 are thermally adhered. But the present invention is not restricted thereto. The line electrodes 42 and the polymer resistor 44 can also be adhered by using a conductive adhesive. The line electrodes 42 and the polymer resistor 44 can also be electrically connected by means of mechanical contact by simply pressing them together.

The sheet heating element 90 can also have the liquid-resistant film 45 described in Embodiment 1 (see FIG. 9C). The polymer resistor 44 is heat-laminated as a film on the liquid-resistant film 45, and the line electrodes 42 are then sewn onto the insulating substrate 41 through the polymer resistor 44 and the liquid-resistant film 45.

The sheet heating element 90 can also have the second insulating substrate 46 described in Embodiment 1 (see FIG. 9D). In addition, the sheet heating element 90 shown in FIG. 9D can have the liquid-resistant film shown in FIG. 9C between the polymer resistor 44 and the first insulating substrate 41.

### Embodiment 5 of a Sheet Heating Element

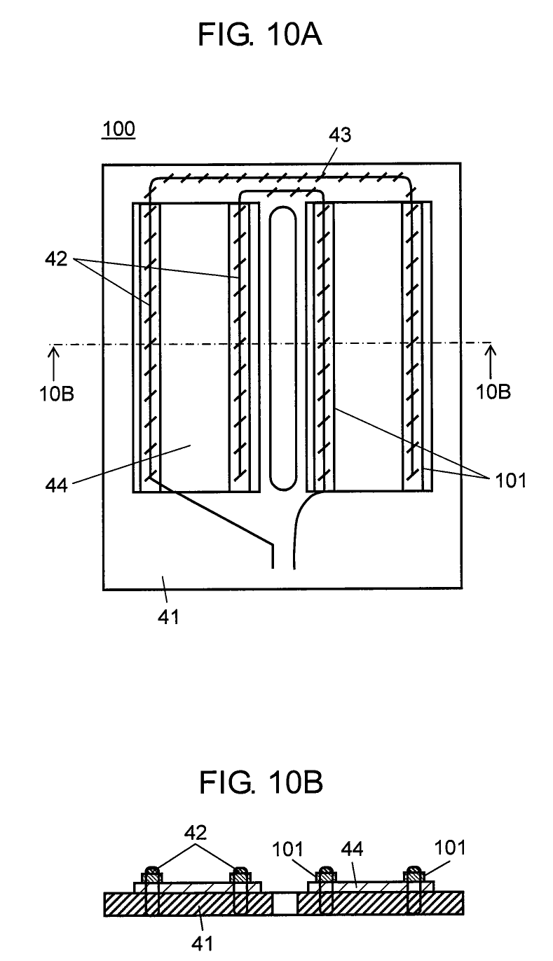

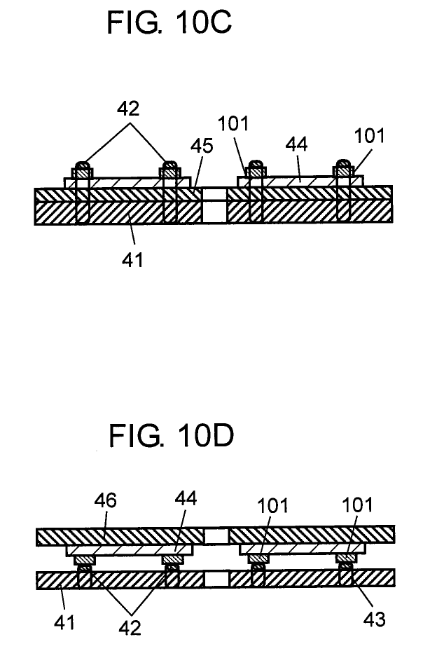

FIG. 10A is a plan view of a sheet heating element 100 of Embodiment 5 of the present invention. FIG. 10B is a sectional view along the line 10B-10B in FIG. 10A. The structure differs from that of Embodiment 4 (see FIG. 9A) in that conductive strips 101 on which the line electrodes 42 are slidable are provided between the polymer resistor 44 and the line electrodes 42.

The sheet heating element 100 of Embodiment 5 is produced as follows. The polymer resistor 44 is heat-laminated as a film on the insulating substrate 41. After that, conductive strips 101 are mounted on this polymer resistor 44. Then, the line electrodes 42 are arranged on the conductive strips 101 and sewn onto the insulating substrate 41 through the conductive strips 101 and the polymer resistor 44 with a sewing machine. The line electrodes 42 and the polymer resistor 44 are subjected to thermal compression treatment, so that the polymer resistor 44 firmly adheres to the line electrodes 42.

The conductive strips 101 are formed, for example, from films produced from dried graphite paste, or from films produced from a resin compound containing graphite. When the conductive strips 101 are mounted on the polymer resistor 44, these films are heat-laminated to the polymer resistor 44, or painted thereon.

Since the line electrodes 42 are slidable on the conductive strips 101, the flexibility of the sheet heating element 100 is increased further. Since the conductive strips 101 have excellent conductivity, the line electrodes 42 and the polymer resistor 44 are more reliably electrically connected via the conductive strips 101.

It should be noted that in this embodiment, it is also possible to additionally provide the auxiliary line electrodes 81 described in Embodiment 3 (see FIG. 8A). Moreover, the conductive strips 101 can also be provided for the auxiliary line electrodes 81.

In this embodiment, the conductive strips 101 are mounted on the polymer resistor 44 after adhering the polymer resistor 44 to the insulating substrate 41. The conductive strips 101 can be attached to the polymer resistor 44 in advance.

The line electrodes 42 and the polymer resistor 44 are thermally adhered. But the present invention is not restricted thereto. The line electrodes 42 and the polymer resistor 44 can also be adhered by using a conductive adhesive. The line electrodes 42 and the polymer resistor 44 can also be electrically connected by means of mechanical contact by simply pressing them together.

The sheet heating element 100 can also have the liquid-resistant film 45 described in Embodiment 1 (see FIG. 10C). The polymer resistor 44 is heat-laminated as a film on the liquid-resistant film 45. The conductive strips 101 are then mounted on the polymer resistor 44. The line electrodes 42 are sewn onto the insulating substrate 41 through the conductive strips 101, the polymer resistor 44 and the liquid-resistant film 45.

The sheet heating element 100 can be provided with a second insulating substrate 46, as shown in FIG. 10D. The polymer resistor 44 is heat-laminated as a film on the second insulating substrate 46. The conductive strips 101 are then mounted on the polymer resistor 44. On the other hand, the line electrodes 42 are sewn onto the first insulating substrate 41. Thereafter, the second insulating substrate 46 is joined with the first insulating substrate 41 by thermal compression treatment so that the line electrodes 42 make contact with the conductive strips 101, forming a unit.

### Embodiment 6 of a Sheet Heating Element

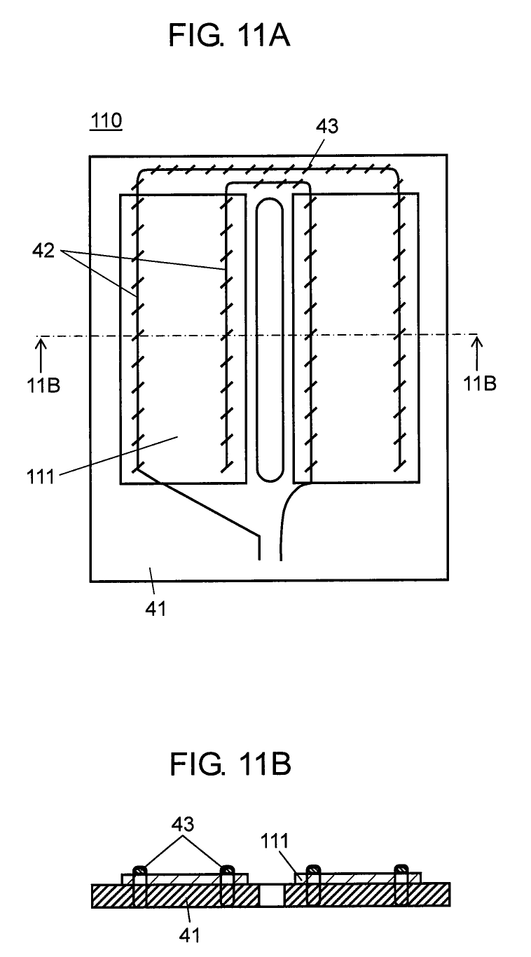

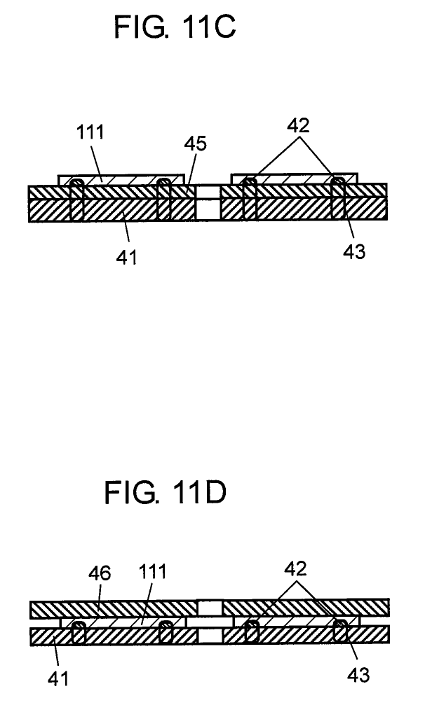

FIG. 11A is a plan view of a sheet heating element 110 of Embodiment 6 of the present invention. FIG. 11B is a sectional view along the line 11B-11B in FIG. 11A. The structure differs from that of Embodiment 4 (see FIG. 9A) in that a polymer resistor 111 is provided instead of the polymer resistor 44. The polymer resistor 111 is produced by impregnating a meshed non-woven fabric or woven fabric with a polymer resistor.

The sheet heating element 110 of Embodiment 6 is produced as follows. An ink is produced by dispersing and mixing a polymer resistor described in Embodiments 1-5 in a liquid such as a solvent. A meshed non-woven fabric or woven fabric is impregnated with this ink by a method such as printing, painting, dipping, or the like, and then dried to produce the polymer resistor 111. The meshed non-woven fabric or woven fabric has a plurality of small pores between the fibers, and the resin resistor infiltrates into these pores.

Next, the line electrodes 42 are arranged on the polymer resistor 111, and sewn onto the insulating substrate 41 with a sewing machine. The polymer resistor 111 is then adhered to the insulating substrate 41 by heat-lamination. The line electrodes 42 and the polymer resistor 111 are subjected to thermal compression treatment, so that the polymer resistor 44 firmly adheres to the line electrodes 42.

In this structure, since the polymer resistor 111 is formed from a meshed non-woven or woven fabric having a plurality of pores, it exhibits a high degree of flexibility because it can easily change the shape under an external force acted thereupon.

Since the polymer resistor is held within the pores in the non-woven fabric or the woven fabric, the polymer resistor 111 closely adheres to the insulating substrate 41, thereby increasing the mechanical strength of the polymer resistor 111.

It should be noted that in this embodiment, a meshed non-woven fabric or woven fabric is impregnated with an ink-type polymer resistor. It is also possible to subject the meshed non-woven fabric or the woven fabric to thermal compression treatment to impregnate the non-woven fabric or the woven fabric with a film-type or sheet-type polymer resistor.

In addition, in this embodiment, the line electrodes 42 and the polymer resistor 111 are thermally adhered. But the present invention is not restricted thereto. The line electrodes 42 and the polymer resistor 111 can also be adhered by using a conductive adhesive. The line electrodes 42 and the polymer resistor 111 can also be electrically connected by means of mechanical contact by simply pressing them together.

Moreover, in this embodiment, it is also possible to provide the auxiliary line electrodes 81 described in Embodiment 3 (see FIG. 8A).

The sheet heating element 110 can also have the liquid-resistant film 45 described in Embodiment 1 (see FIG. 11C). The polymer resistor 111 and the liquid-resistant film 45 are adhered by lamination

The sheet heating element 110 can be provided with a second insulating substrate 46, as shown in FIG. 11D. A non-woven or woven meshed fabric is impregnated with a polymer resistor material, forming the polymer resistor 111. The polymer resistor 111 and the second insulating substrate 46 are attached by heat-lamination. The line electrodes 42 are sewn by machine onto the first insulating substrate 41. The first and second insulating substrates 41, 46 are joined with the first insulating substrate 41 by thermal compression treatment, so that the line electrodes 42 make contact with the line electrodes 42 and the polymer resistor 111.

The second insulating substrate 46 may be provided to the sheet heating element 110 shown in FIG. 11C.

### Embodiment 7 of a Sheet Heating Element

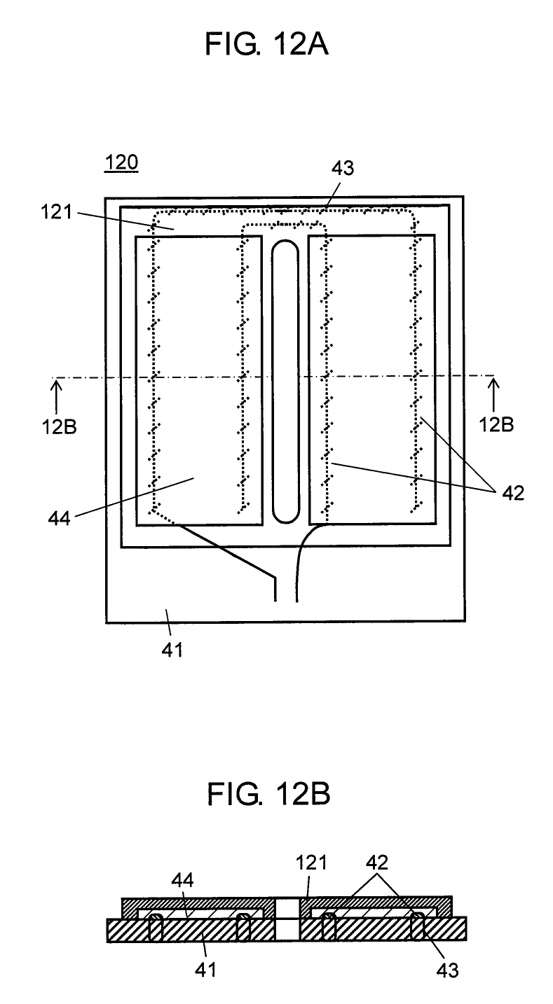

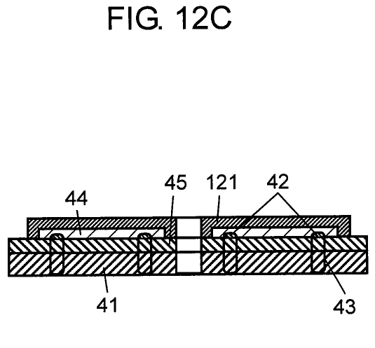

FIG. 12A is a plan view of a sheet heating element 120 of Embodiment 7 of the present invention. FIG. 12B is a sectional view along the line 12B-12B in FIG. 12A. The structure differs from that of Embodiment 1 (see FIG. 4A) in that a cover layer 121 is further provided on the polymer resistor 44.

The cover layer 121 is formed from a material possessing electrical insulation properties. After using heat-lamination to laminate the polymer resistor 44 to the insulating substrate 41 to which the line electrodes 42 have already been attached, the cover layer 121 is also attached by heat-lamination, so as to cover the polymer resistor 44.

The cover layer 121 has as its primary component either a polyolefin-based thermoplastic elastomer, a styrene-based thermoplastic elastomer, or a urethane-based thermoplastic elastomer used by itself, or a combination thereof used as the primary component. The thermoplastic elastomer imparts flexibility to the sheet heating element 120.

The cover layer 121 protects the sheet heating element 120 from impact and scratching which may damage the sheet heating element 120.

Furthermore, when the heating element is used in a car seat heater or such conditions as subjecting the heating element to a constant external force consisting of sliding, the cover layer 121 prevents abrasion of the polymer resistor 44, so the sheet heating element 120 will not lose its heat-emitting function.

Moreover, since the sheet heating element 120 is electrically isolated, it is safe, even if high voltage is applied to the sheet heating element 120.

The cover layer 121 should be provided so as to cover the polymer resistor 44 in its entirety. However, keeping flexibility in mind, it is preferable to use a thin covering layer as the cover layer 121.

The sheet heating element 120 can also have the liquid-resistant film 45 described in Embodiment 1 (see FIG. 12C). The liquid-resistant film 45 is heat-laminated to the insulating substrate 41. The line electrodes 42 are sewn onto the insulating substrate 41 through the liquid-resistant film 45. After heat-laminating the polymer resistor 44 onto the liquid-resistant film 45, the cover layer 121 is heat-laminated.

### Embodiment 8 of a Sheet Heating Element

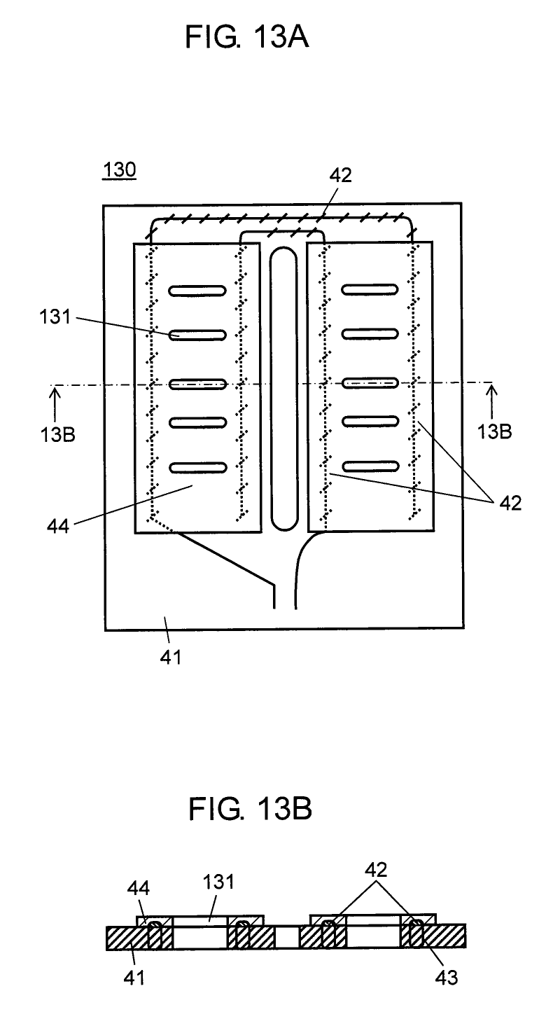

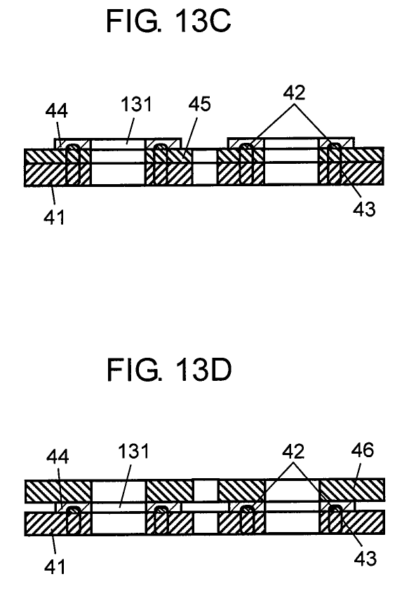

FIG. 13A is a plan view of a sheet heating element 130 of Embodiment 8 of the present invention. FIG. 13B is a sectional view along the line 13B-13B in FIG. 13A. The structure differs from that of Embodiment 1 (see FIG. 4A) in that at least either the insulating substrate 41 and/or the polymer resistor 44 is provided with a plurality of slits 131.

The sheet heating element 130 of Embodiment 8 is produced as follows. First, as in Embodiment 1, the line electrodes 42 are arranged on the insulating substrate 41 and sewn thereon. Using T-die extrusion molding, the polymer resistor 44 is extruded as a film or sheet and thermally adhered to the insulating substrate 41. After punching the central portion of the insulating substrate 41 to form elongated holes, a Thomson punch is used to form a plurality of slits 131 in the polymer resistor 44 and the insulating substrate 41.

The sites punched with a Thomson puncher are not restricted to the sites shown in the drawing. Depending on the shape of the seat cover 53 of a car seat, punching can be provided in places other than the sites shown in the drawing. In this case, it may be necessary to modify the wiring pattern of the line electrodes 42.

Furthermore, the line electrodes 42 and the polymer resistor 44 can be attached to the insulating substrate 41 on which have already been formed the slits 131 punched by a Thomson puncher. In the alternative, the polymer resistor 44 can be attached to a separator such as polypropylene or mold release paper (not shown). Then, the slits 131 are formed in the polymer resistor 44 by punching prior to attaching to the insulating substrate 41. In the former case, the slits 131 are formed only in the insulating substrate 41, and in the latter case, the slits 131 are formed only in the polymer resistor 44.

Since a plurality of slits 131 are formed in the sheet heating element 130 of this embodiment, the sheet heating element 130 can easily change the shape in response to an external force, so the feeling of comfort is enhanced when seated upon. An elongated hole formed in the central portion of the insulating substrate 41 may also be thought to serve to give flexibility to the sheet heating element 130. However, the elongated hole is provided to attach the sheet heating element 130 to the seat, and is not provided to give flexibility to the sheet heating element 130. Therefore, it has to be functionally distinguished from the slits 131.

It should be noted that the slits 131 of this embodiment can also be formed on the sheet heating elements of Embodiments 1-7.

The sheet heating element 130 can also have the liquid-resistant film 45 described in Embodiment 1 (see FIG. 13C). First, the line electrodes 42 are sewn onto the insulating substrate 41 through the liquid-resistant film 45, as in Embodiment 1. Using T-die extrusion molding, the polymer resistor 44 is extruded as a film, and the polymer resistor 44 is thermally adhered to the line electrodes 42 and the liquid-resistant film 45. After punching the central portion of the insulating substrate 41, a Thomson punch is used to form slits 131 between the line electrodes 42, passing from the polymer resistor 44 through to the insulating substrate 41.

The sheet heating element 130 can be provided with a second insulating substrate 46, as shown in FIG. 13D. First, the line electrodes 42 are sewn onto the first insulating substrate 41. On the other hand, using T-die extrusion molding, the polymer resistor 44 is extruded as a film or sheet and thermally adhered to the second insulating substrate 46. The first and second insulating substrates 41, 46 are joined by thermal compression treatment, so that the line electrodes 42 and the polymer resistor 44 make contact with each other. After punching the central portion of the first insulating substrate 41 and the second insulating substrate 46, a Thomson punch is used to form slits 131 passing through the first insulating substrate 41, the polymer resistor 44, and the second insulating substrate 46.

The slits 131 can be formed in advance by punching the first and second insulating substrates 41, 42 using a Thomson punch. In the alternative, the polymer resistor 44 can be attached to a separator such as polypropylene or mold release paper (not shown), and the slits 131 can be formed in the polymer resistor 44 by punching. In the former case, the slits 131 are formed only in the insulating substrate 41, 46, and in the latter case, the slits 131 are formed only in the polymer resistor 44.

### Embodiment 9 of a Sheet Heating Element

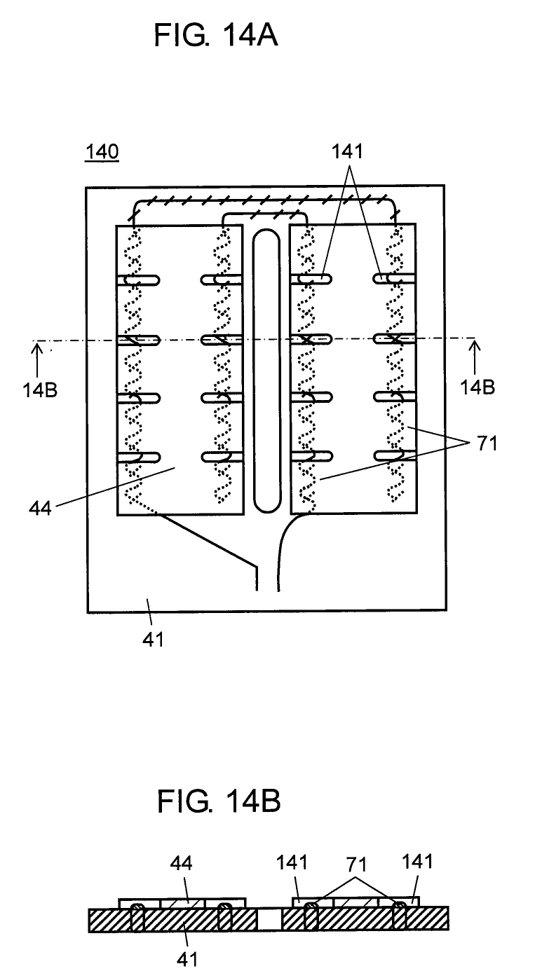

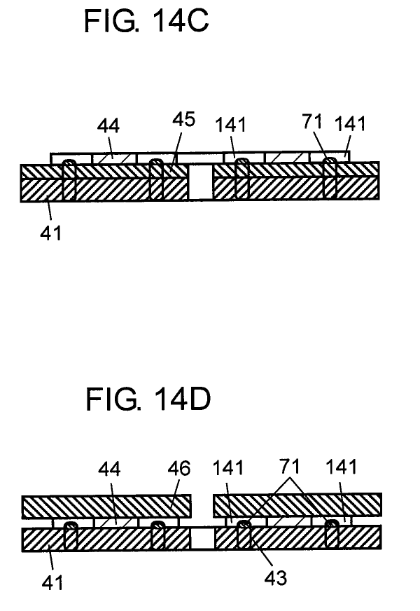

FIG. 14A is a plan view of a sheet heating element 140 of Embodiment 9 of the present invention. FIG. 14B is a sectional view along the line 14B-14B in FIG. 14A. The structure differs from that of Embodiment 8 (see FIG. 13A) in that a plurality of notches 141 are provided, instead of the slits 131.

The sheet heating element 140 of Embodiment 9 is produced as follows. First, the polymer resistor 44 is attached to a separator such as polypropylene or mold release paper (not shown), and the polymer resistor 44 is punched to form the notches 141. Next, heat-lamination is used to attach the polymer resistor 44 to the insulating substrate 41 on which the wave-shaped line electrodes 71 have been sewn, after which the separator is removed from the polymer resistor 44.

Since the polymer resistor 44 easily changes the shape in response to an external force, due to the notches 141, the feeling of comfort is enhanced when seated thereon.

Moreover, similar notches 141 can be formed on the insulating substrate 41. In this case, these notches 141 serve the above-described function significantly, making it possible to further enhance the feeling of comfort when seated thereon.

The notches 141 of this embodiment can also be formed in the sheet heating elements of Embodiments 1-7.

The sheet heating element can also have the liquid-resistant film 45 described in Embodiment 1 (see FIG. 14C). First, the wave line electrodes 71 are sewn onto the insulating substrate 41 through the liquid-resistant film 45. The polymer resistor 44 is attached to a separator such as polypropylene or mold release paper (not shown), and punched to form the notches 141 in the polymer resistor 44. Using a heat-laminator, the polymer resistor 44 is attached to the liquid-resistant film 45, after which the separator is removed.

The sheet heating element 140 can be provided with a second insulating substrate 46, as shown in FIG. 14D. First, the polymer resistor 44 is attached to a separator such as polypropylene or mold release paper (not shown), and punched to form the notches 141 in the polymer resistor 44. After heat-laminating the polymer resistor 44 to the second insulating substrate 46, the separator is removed. On the other hand, the line electrodes 42 are sewn in a wave-shape onto the first insulating substrate 41. Then, the first and second insulating substrates are joined by thermal compression treatment, using a heat-laminator, so that the line electrodes 42 and the polymer resistor 44 make contact, forming a unit.

The sheet heating element 140 as shown in FIG. 14C may have the second insulating substrate 46.

### INDUSTRIAL APPLICABILITY

The sheet heating element of the present invention has a simple structure, an excellent PTC characteristic, and has flexibility in easily changing the shape in response to an external force. Since this sheet heating element can be attached to surfaces of appliances which have a complex surface topography, it can be used in heaters for car seats and steering wheels, and also in appliances such as electric floor heaters that require heat. Moreover, the range of application is extensive, because of excellent manufacturing productivity and cost reduction.

1. A sheet heating element comprising:
a substrate sheet made of an electrically insulative material;
lines made of electrically conductive materials and arranged with a distance between them on the substrate sheet; and
at least one PTC resistor sheet being in electrical contact with the lines and configured to heat up in a self-regulated manner in response to a supply of electricity from the lines.

2. A sheet heating element according to claim 1, wherein the at least one PTC resistor sheet has a thickness of 20-200 micrometers.

3. A sheet heating element according to claim 1, wherein the at least one PTC resistor sheet has a thickness of 30-100 micrometers.

4. A sheet heating element according to claim 1, wherein the at least one PTC resistor sheet comprises a resin composition and a conductive material.

5. A sheet heating element according to claim 4, wherein the resin composition comprises a reactant resin and a reactive resin which is cross-linked with the reactant resin.

6. A sheet heating element according to claim 4, wherein the conductive material comprises at least one of carbon black and graphite.

7. A sheet heating element according to claim 1, wherein the at least one PTC resistor sheet is thermally fusible to effect the electrical contact with the lines.

8. A sheet heating element according to claim 1, wherein the at least one PTC resistor sheet has an electric resistivity ranging between 0.0007 Ωm and 0.016 Ωm.

9. A sheet heating element according to claim 1, wherein the at least one PTC resistor sheet has an electric resistivity ranging between 0.0011 Ωm and 0.0078 Ωm.

10. A sheet heating element according to claim 1, wherein the at least one PTC resistor sheet comprises a flame retardant agent.

11. A sheet heating element according to claim 10, wherein the flame retardant agent comprises at least one of a phosphorus-based flame retardant, a nitrogen-based flame retardant, a silicone-based flame retardant, an inorganic flame retardant and a halogen-based flame retardant.

12. A sheet heating element according to claim 10, wherein the at least one PTC resistor sheet satisfies at least one of the following conditions:
(a) When an end of the at least one PTC resistor sheet is burned with a gas flame, and the gas flame is extinguished after 60 seconds, said sheet does not burn, even if said sheet is charred;
(b) When an end of the at least one PTC resistor sheet is burned with a gas flame, said sheet catches fire for no more than 60 seconds, but the flame extinguishes within 2 inches; or
(c) When an end of the at least one PTC resistor sheet is burned with a gas flame, even if said sheet catches fire, the flame does not advance at a rate of 4 inches/minute or more in an area ½ inch thick from the surface.

13. A sheet heating element according to claim 10, wherein the flame retardant agent is contained in the at least one PTC resistor sheet at a content of 5 wt. % or more.

14. A sheet heating element according to claim 10, wherein the flame retardant agent is contained in the at least one PTC resistor sheet at a content of 10-30 wt. %.

15. A sheet heating element according to claim 10, wherein the flame retardant agent is contained in the at least one PTC resistor sheet at a content of 15-25 wt. %.

16. A sheet heating element according to claim 1, wherein the at least one PTC resistor sheet comprises a liquid-resistant resin.

17. A sheet heating element according to claim 16, wherein the liquid-resistant resin is contained at a content of 10 wt. % or more in the at least one PTC resistor sheet.

18. A sheet heating element according to claim 16, wherein the liquid-resistant resin is contained at a content of 10-70 wt. % in the at least one PTC resistor sheet.

19. A sheet heating element according to claim 16, wherein the liquid-resistant resin is contained at a content of 30-50 wt. % in the at least one PTC resistor sheet.

20. A sheet heating element according to claim 16, wherein the liquid-resistant resin comprises at least one of an ethylene/vinyl alcohol copolymer, a thermoplastic polyester resin, a polyamide resin, a polypropylene resin and an ionomer.

21. A sheet heating element according to claim 1, wherein the at least one PTC resistor sheet heats up in a self-regulated manner between about 40° C. and about 45° C.

22. A sheet heating element according to claim 1, wherein the lines are sewed onto the substrate sheet.

23. A sheet heating element according to claim 1, wherein the lines have a diameter equal to or less than 1 mm.

24. A sheet heating element according to claim 1, wherein the lines have a diameter equal to or less than 0.5 mm.

25. A sheet heating element according to claim 1, wherein the lines have a resistivity equal to or less than 1 (Ω/m).

26. A sheet heating element according to claim 1, wherein the electrically conductive material which forms the lines is any one of copper, tin-plated copper, and a copper-silver alloy.

27. A sheet heating element according to claim 1, wherein the lines are formed by twisting together 19 copper-silver alloy wires with a diameter of 0.05 micrometers.

28. A sheet heating element according to claim 1, wherein the lines are arranged at an interval of about 70-150 mm.

29. A sheet heating element according to claim 1, wherein the at least one PTC resistor sheet exhibits an elasticity equal to or higher than that of the substrate sheet.

30. A sheet heating element according to claim 1, wherein the at least one PTC resistor sheet extends by more than 5% with a load of less than 7 kgf.

31. A sheet heating element according to claim 1, wherein the substrate sheet is made of either a non-woven or woven fabric formed from polyester fibers.

32. A sheet heating element according to claim 30, wherein the substrate sheet is punched with a needle.

33. A sheet heating element according to claim 1, further comprising a cover sheet made of an electrically insulative material and cooperative with the substrate sheet to enclose the lines and the at least one PTC resistor sheet.

34. A sheet heating element according to claim 33, wherein the cover sheet is made of either a non-woven or woven fabric formed from polyester fibers.

35. A sheet heating element according to claim 33, wherein at least one of the substrate sheet and the cover sheet comprises a flame retardant agent.

36. A sheet heating element according to claim 35, wherein the flame retardant agent comprises at least one of a phosphorus-based flame retardant, a nitrogen-based flame retardant, a silicone-based flame retardant, an inorganic flame retardant and a halogen-based flame retardant.

37. A sheet heating element according to claim 35, wherein the at least one of the substrate sheet and the cover sheet satisfies at least one of the following conditions:
(a) When an end of the at least one of the substrate sheet and the cover sheet is burned with a gas flame, and the gas flame is extinguished after 60 seconds, said sheet does not burn, even if said sheet is charred;
(b) When an end of the at least one of the substrate sheet and the cover sheet is burned with a gas flame, said sheet catches fire for no more than 60 seconds, but the flame extinguishes within 2 inches; or (c) When an end of the at least one of the substrate sheet and the cover sheet is burned with a gas flame, even if said sheet catches fire, the flame does not advance at a rate of 4 inches/minute or more in an area ½ inch thick from the surface.

38. A sheet heating element according to claim 35, wherein the flame retardant agent is contained at a content of 5 wt. % or more in the at least one of the substrate sheet and the cover sheet.

39. A sheet heating element according to claim 35, wherein the flame retardant agent is contained at a content of 10-30 wt. % in the at least one of the substrate sheet and the cover sheet.

40. A sheet heating element according to claim 35, wherein the flame retardant agent is contained at a content of 15-25 wt. % in the at least one of the substrate sheet and the cover sheet.

41. A sheet heating element according to claim 1, wherein the lines are disposed between the at least one PTC resistor sheet and the substrate sheet.

42. A sheet heating element according to claim 1, further comprising a liquid-resistant film.

43. A sheet heating element according to claim 42, wherein the liquid-resistant film comprises at least one of an ethylene/vinyl alcohol copolymer, a thermoplastic polyester resin, a polyamide resin, a polypropylene resin and an ionomer.

44. A sheet heating element according to claim 42, wherein the liquid-resistant film has a thickness of 5-100 micrometers.

45. A sheet heating element according to claim 42, wherein the liquid-resistant film has a thickness of 10-50 micrometers.

46. A sheet heating element according to claim 42, wherein the liquid-resistant film is disposed between the at least one PTC resistor sheet and the substrate sheet.

47. A sheet heating element according to claim 42, wherein the liquid-resistant film comprises a flame retardant agent.

48. A sheet heating element according to claim 47, wherein the flame retardant agent comprises at least one of a phosphorus-based flame retardant, a nitrogen-based flame retardant, a silicone-based flame retardant, an inorganic flame retardant and a halogen-based flame retardant.

49. A sheet heating element according to claim 47, wherein the liquid-resistant film satisfies at least one of the following conditions:
(a) When an end of the liquid-resistant film is burned with a gas flame, and the gas flame is extinguished after 60 seconds, the liquid-resistant film does not burn, even if the substrate sheet is charred;
(b) When an end of the liquid-resistant film is burned with a gas flame, the liquid-resistant film catches fire for no more than 60 seconds, but the flame extinguishes within 2 inches; or
(c) When an end of the liquid-resistant film is burned with a gas flame, even if the liquid-resistant film catches fire, the flame does not advance at a rate of 4 inches/minute or more in an area ½ inch thick from the surface.

50. A sheet heating element according to claim 47, wherein the flame retardant agent is contained at a content of 5 wt. % or more in the liquid-resistant film.

51. A sheet heating element according to claim 47, wherein the flame retardant agent is contained at a content of 10-30 wt. % in the liquid-resistant film.

52. A sheet heating element according to claim 47, wherein the flame retardant agent is contained at a content of 15-25 wt. % in the liquid-resistant film.

53. A sheet heating element according to claim 1, wherein at least one of the lines runs in a wavy manner.

54. A sheet heating element according to claim 1, wherein the lines are arranged such that more than two lines supply electricity to each of the at least one PTC resistor sheet.

55. A sheet heating element according to claim 1, wherein the at least one PTC resistor sheet is disposed between the lines and the substrate sheet.

56. A sheet heating element according to claim 1, further comprising conductive films disposed between the lines and the at least one PTC resistor sheet which allow the lines to slide thereon.

57. A sheet heating element according to claim 56, wherein the conductive films are made from one of graphite paste and a resin compound containing graphite.

58. A sheet heating element according to claim 1, wherein the at least one PTC resistor sheet comprises a non-woven or woven fabric impregnated with a PTC resistor material.

59. A sheet heating element according to claim 1, further comprising a cover film made of thermoplastic elastomer.

60. A sheet heating element according to claim 59, wherein the cover film made of at least one of a polyolefin-based thermoplastic elastomer, a styrene-based thermoplastic elastomer, and a urethane-based thermoplastic elastomer.

61. A sheet heating element according to claim 1, wherein at least one of the substrate sheet and the at least one PTC resistor sheet is formed with a plurality of slits.

62. A sheet heating element according to claim 1, wherein at least one of the substrate sheet and the at least one PTC resistor sheet is formed with a plurality of notch.
